(19) United States
(12) Patent Application Publication
(10) Pub. No.: US 2016/0065511 A1
(43) Pub. Date: Mar. 3, 2016

(54) DISPLAYING EMAIL ATTACHMENTS ON A WEBMAIL PAGE

(71) Applicant: YANDEX EUROPE AG, Luzern (CH)

(72) Inventors: Egor Vladimirovich GANIN, Podolsky district (RU); Natalia Grigorievna SIZONENKO, Moscow (RU)

(21) Appl. No.: 14/937,450

(22) Filed: Nov. 10, 2015

Related U.S. Application Data
(63) Continuation of application No. PCT/IB2014/062033, filed on Jun. 6, 2014.

(30) Foreign Application Priority Data
Oct. 2, 2013 (RU) 2013144680

(51) Int. Cl. H04L 12/58

(52) U.S. Cl. CPC H04L 51/08; H04L 51/063

(57) ABSTRACT

Disclosed are a method and a system for displaying email attachments on a webmail page. An email server receives a request for pending email messages from a communication device associated with an email receiver. The email server retrieves from an email database pending email messages having a destination address designating the email receiver. Some of pending email messages include email attachments. The email server sends a trigger to the communication device. The trigger includes information instrumental in causing the communication device to display a webmail page viewable by the email receiver. This webmail page shows several lines of pending email messages. Each line shows an identity of a sender and a title of a pending email message. For an email message having an email attachment, the line also shows a thumbnail representative of the email attachment.

### CROSS-REFERENCE

The present application claims convention priority to Russian Utility Model Application No. 2013144680, filed on Oct. 2, 2013, entitled “ [symbol] [symbol] [symbol] [symbol] [symbol] [symbol] [symbol] [symbol] [symbol] ” and is a continuation of International Application No. PCT/IB2014/062033 filed on Jun. 6, 2014, entitled “DISPLAYING EMAIL ATTACHMENTS ON A WEBMAIL PAGE”, the entirety of both of which are incorporated herein by reference.

### FIELD

The present technology relates to methods and systems for processing email messages.

### BACKGROUND

Electronic mail messages, usually shortened as ‘email’ or ‘e-mail’, have become a very common means of communication. Indeed, in many situations, email messaging has replaced the standard post letter, the telephone and the facsimile as the preferred means of communication.

Conventional email messages are typically formatted for exchange over the Internet in the format defined in RFC 5322 (available at, for example, http://tools.ietf.org/html/rfc5322). In the Internet email message format, an email message consists of two basic sections, the header and the body. The header of the email message is structured in various fields that contain information about the email message. The body of the email message contains the content of the email message. Each of these will be discussed in turn.

Typical header fields include:
A “from” field identifying the sender of the email message by Internet email address and in most cases by name.
A “to” field identifying the recipient(s) of the email message by Internet email address and optionally by name.
A “cc” field identifying persons receiving a copy of the email message by Internet email address and optionally by name.
A “bcc” field identifying persons receiving a blind copy of the email message by Internet email address and optionally by name.
A “subject” field typically providing a brief summary of the topic of the email message.
A “date” field identifying the date and time that the email message was sent (typically in local time and Greenwich Mean Time).
A “message-ID” field providing a unique character string in respect of the email message.

The above list is only intended as a brief summary of email header fields typically found in most email messages. It is not a complete list of all possible email header fields. (See also RFC 5322 referred to above and RFC 3864, available at, for example, http://tools.ietf.org/html/rfc3864).

As was noted above, the body of the email message includes the message's content. The content is typically either in plain text or HyperText Markup Language (HTML) and is typically encoded using an encoding scheme such as ASCII or Unicode.

An email message may have one or more attachments (files) attached thereto. There is a priori no limit to the types of files that may be attached to an email message. Examples of files that are frequently attached to email messages include image files, such as JPEG, GIF, TIFF, PDF and BMP files, audio files such as MP3 files WAV files, video files such as AVI and MOV files, text files, presentations or spreadsheets created using an office suite such as Windows Office™ or OpenOffice™, and the like. This list is not exhaustive and many other types of files can be attached to email messages.

Conventionally, contents of attachments to an email message are only visible to an email receiver following opening the email message. The attachments may be displayed as selectable icons in a header of an email presentation page. Generally, the selectable icons only provide an indication of a type of the attachment. Some attachments, particularly image files, may alternatively be shown in the body of the email message, for example inserted as HTML objects within a text of the email message.

FIG. 1 is an example screenshot of a conventional webmail page. A webmail page 100 is viewable on a terminal of an email receiver, for example on a browser. The webmail page 100 shows a plurality of lines 102 that, together, form a list of recent email messages addressed to the email receiver. Each line 102 provides information about a particular email message. More specifically, each line 102 shows an identity 104 of a sender of the email message, a title 106 of the email message, and a date or time 108 when the email message was sent from the sender. A small picture 114 representing the sender may be included, if available (otherwise a filler image may be displayed). First few words 110 of a text content of the email message may also be shown. On each line 102, a box 112 can be selected by the email receiver to execute an action chosen by clicking on a command related to the email message.

Generally, performing a so-called ‘double-click’ operation on the line 102 results in opening of the email message, for example by opening another browser window or another tab on the browser window that shows the webmail page 110, the newly opened browser window or tab displaying the content of the email message.

Other content elements of the webmail page 100 are not relevant to the present disclosure and should be self-explanatory to the skilled reader. Other frequently shown fields, not included in the webmail page 100 of FIG. 1, include for example a size of each email message, expressed in kilobytes or in megabytes.

The contents of a given line 102 are displayed in bold font when the corresponding email message has not been previously opened by the email receiver. The contents of a given line 102 that is not in bold font indicates that it refers to an email message that has already been opened by the email receiver.

Line 102A shows an icon 120, usually illustrating a paper clip, indicating that a particular email message contains one or more attachments. A nature and content of the one or more attachments is not suggested by the icon 120. The email receiver may not readily appreciate how interesting or urgent the content of the one or more attachment might be. Moreover, some email attachments include malicious contents, such as viruses, worms, or other types of malware. Even when the sender of the email message, designated by the identity 104, is known to be a reliable person, that sender may have accidentally forwarded a malicious attachment. The email receiver cannot always detect a suspicious email message and determine that it should not be opened, but rather be deleted.

There would therefore be advantages in providing to the receiver of an email message an early indication of a content of attachments included in email messages.

### SUMMARY

It is an object of the present technology to ameliorate at least some of the inconveniences present in the prior art.

In one aspect, embodiments of the present technology provide a method for displaying email attachments on a webmail page. Accordingly, an email server receives, from a communication device associated with an email receiver, a request for pending email messages for the email receiver. The email server retrieves, from an email database, one or more pending email messages having a destination address designating the email receiver, the one or more pending email messages including an email message having at least one email attachment. The email server sends a trigger to the communication device. This trigger is instrumental in causing the communication device to display a webmail page viewable by the email receiver. This webmail page shows, on each of one or more lines, an identity of a sender of one of the one or more pending email messages and a title of the one of the one or more pending email messages. The webmail page further shows, on a line for the email message having the at least one email attachment, at least one thumbnail representative of the at least one email attachment.

In another aspect, the present technology provides a system for displaying email attachments on a webmail page. The system comprises an email server including at least one computer processor, a communication interface operationally connected with the computer processor and structured and configured to communicate with an email database and with at least one communication device associated with an email receiver, and a non-transient computer information storage medium operationally connected with the computer processor, the non-transient computer information storage medium storing program instructions. When executed by the at least one computer processor the program instructions effect:
receiving, from the communication device associated with the email receiver, a request for pending email messages for the email receiver;
retrieving, from the email database, of one or more pending email messages having a destination address designating the email receiver, the one or more pending email messages including an email message having at least one email attachment; and
sending to the communication device a trigger, the trigger being instrumental in causing the communication device to display a webmail page viewable by the email receiver, the webmail page showing, on each of one or more lines, an identity of a sender of one of the one or more pending email messages and a title of the one of the one or more pending email messages, the webmail page further showing, on a line for the email message having the at least one email attachment, at least one thumbnail representative of the at least one email attachment.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

In the context of the present specification, a “server” is a computer program that is running on appropriate hardware and is capable of receiving requests (e.g. from client devices such as communication devices associated with email receivers) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” and “communication device” are synonymous and designate any electronic device or computer hardware that is capable of running software appropriate to the relevant task at hand and is capable further of communicating with a server, either directly or through a network, by means of a wired connection including without limitation a cable or optical fiber connection, or by means of a wireless connection including without limitation a cellular, WiFi or Bluetooth™ connection. Thus, some (non-limiting) examples of client devices or communication devices include personal computers (desktops, laptops, netbooks, etc.), and mobile devices such as smartphones and tablets, as well as network equipment such as routers, switches, and gateways. It should be noted that a device acting as a client device or communication device in the present context is not precluded from acting as a server to other client devices or communication devices. The use of the expressions “a client device” and “a communication device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, an email attachment includes files of any type including, without limitation, image files, such as JPEG, GIF, TIFF, PDF and BMP files, audio files such as MP3 files WAV files, video files such as AVI and MOV files, text files, presentations or spreadsheets created using an office suite such as Windows Office™ or OpenOffice™, and the like.

In the context of the present specification, the expression “component” is meant to include software (appropriate to a particular hardware context) that is both necessary and sufficient to achieve the specific function(s) being referenced.

In the context of the present specification, the expression “computer information storage medium” is intended to include media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage medium, including two or more media components of a same type and/or two or more media components of different types.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is an example screenshot of a conventional webmail page;

FIG. 2 is a flow diagram showing operations of a method for displaying email attachments on a webmail page according to an embodiment;

FIG. 3 is a flow diagram showing operations of a method for preparing an email message for presentation of an email attachment in the form of a thumbnail according to an embodiment;

FIG. 4a is an example screenshot of a webmail page displaying email attachments as thumbnail images;

FIG. 4b is a second view of the example screenshot of FIG. 4a showing an overlaying window displaying additional thumbnail images;

FIG. 4c is a third view of the example screenshot of FIG. 4a showing an overlaying window displaying a full content of an email attachment;

FIG. 4d is another example of a webmail page displaying email attachments as thumbnail images on a mobile communication device; and

FIG. 5 is a block diagram showing elements of a system for displaying email attachments on a webmail page according to an embodiment.

### DETAILED DESCRIPTION

The present technology provides a method and a system for displaying email attachments on a webmail page. In an embodiment, a receiver of email messages uses a communication device to access an email server that provides information necessary for the communication device to display a webmail page. The webmail page shows a plurality of lines, each line relating to a particular email message intended to the receiver of email messages. If the email server determines that the particular email message contains an email attachment, the email server provides information, in the form of a trigger, instrumental in causing the communication device to generate the webmail page. In more details, the trigger includes information that is instrumental in enabling the communication device to display, on a line of the webmail page corresponding to the particular email message, a thumbnail that forms a representation of the email attachment. The thumbnail is a small image that can represent an actual content of the email attachment—for example by showing a scaled down version of an attached image file. The thumbnail can represent a part of the actual content of the email attachment—for example by showing a first page of a text when the email attachment comprises a multi-page text file. The thumbnail can alternatively represent a type of file for the attachment file—for example by conferring to the thumbnail a shape of a logo representing an application program usable to create or to consult the email attachment.

Though this is not precluded, the present technology does not require any particular implementation or modification to the communication device that receives the trigger. The trigger includes commands, such as HTML commands, that a conventional browser can use to display the webmail page as it would display any other web page. Therefore, the email server configures the information elements to be displayed on the webmail page, including configuring their aspect and location on the page. The trigger includes the definitions of the information elements to be displayed by the communication device, these information elements including one or more thumbnails.

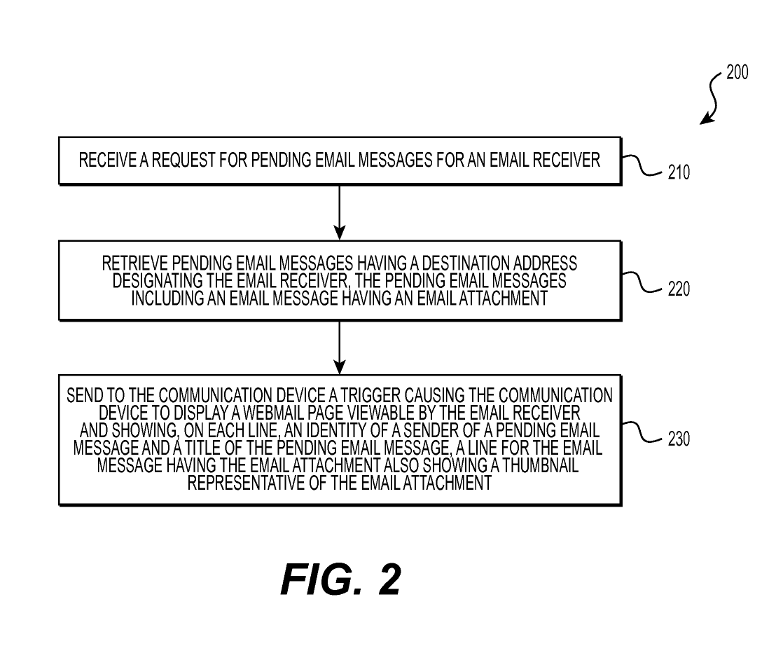

Referring now to the drawings, FIG. 2 is a flow diagram showing operations of a method for displaying email attachments on a webmail page according to an embodiment. A sequence 200 comprises a plurality of operations that may be executed in variable order, some of the operations possibly being executed concurrently, some of the operations being optional. Operation 210 comprises receiving at an email server, from a communication device associated with an email receiver, a request for pending email messages for the email receiver. The request usually originates from a browser associated with the communication device. The email server retrieves from an email database one or more pending email messages having a destination address designating the email receiver in operation 220. The one or more pending email messages include an email message having at least one email attachment. At operation 230, the email server sends a trigger to the communication device. This trigger is instrumental in causing the communication device to display a webmail page viewable by the email receiver. The webmail page shows, on each of one or more lines, an identity of a sender of one of the one or more pending email messages and a title of the one or more pending email messages. The webmail page further shows, on a line for the email message having the at least one email attachment, at least one thumbnail representative of the at least one email attachment.

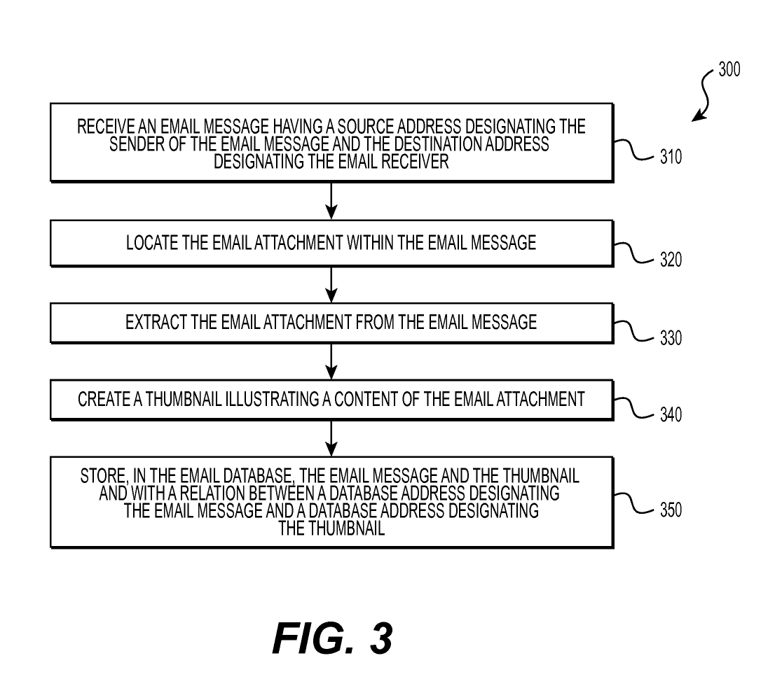

FIG. 3 is a flow diagram showing operations of a method for preparing an email message for presentation of an email attachment in the form of a thumbnail according to an embodiment. A sequence 300 comprises a plurality of operations that may be executed in variable order, some of the operations possibly being executed concurrently, some of the operations being optional. At operation 310, the email server receives an email message having a source address designating a sender of the email message and the destination address designating the email receiver mentioned in the description of operation 210. The email server locates email attachments within the email message at operation 320. If one or more email attachments are found, the email server extracts the email attachments from the email message at operation 330. Extraction takes place whether or not the email attachments are embedded within a content of the email message. Extraction of email attachments comprises distinguishing the email attachments from other HTML elements that may be part of the email message, in those embodiments where the e-mail message is formatted in HTML. These other HTML elements are not counted as email attachments. A thumbnail corresponding to the each located email attachment is created by the email server at operation 340. Each thumbnail illustrates a content of the corresponding attachment. In some embodiments of the present technology, several thumbnails representative of the attachment can be created, each of the several thumbnails being at a different resolution, for example. At operation 350, the email server stores in an email database the email message and each thumbnail so created. By storing the email message and the thumbnails, the email server establishes a relation between a database address designating the email message and database addresses designating each of the thumbnails. More particularly, the relation between the database address designating the email message and the database address designating each of the thumbnails can be used by the email server, in operation 220, to retrieve the thumbnail the email database.

Generally, at least a part of the sequence 300 is executed, for a given email message having an email attachment, before retrieval thereof by the email server at operation 220. The thumbnails corresponding to the email attachments of a given message can thus be created at operation 340 and stored in the email database at operation 350 prior to receiving the request for pending email messages at operation 210. Alternatively, the thumbnails can be created at operation 340 concurrently with treatment of the request received at operation 210. In a variant in which the creation of the thumbnail does not precede receiving the request for pending email messages, the email server may send to the communication device, at operation 230, a first trigger including information causing the communication device to display a pseudo thumbnail indicative of an email attachment on the line for the email message having that email attachment. When the actual thumbnail has been created, the email server sends to the communication device a second trigger instrumental in causing the communication device to replace the pseudo thumbnail with the actual thumbnail.

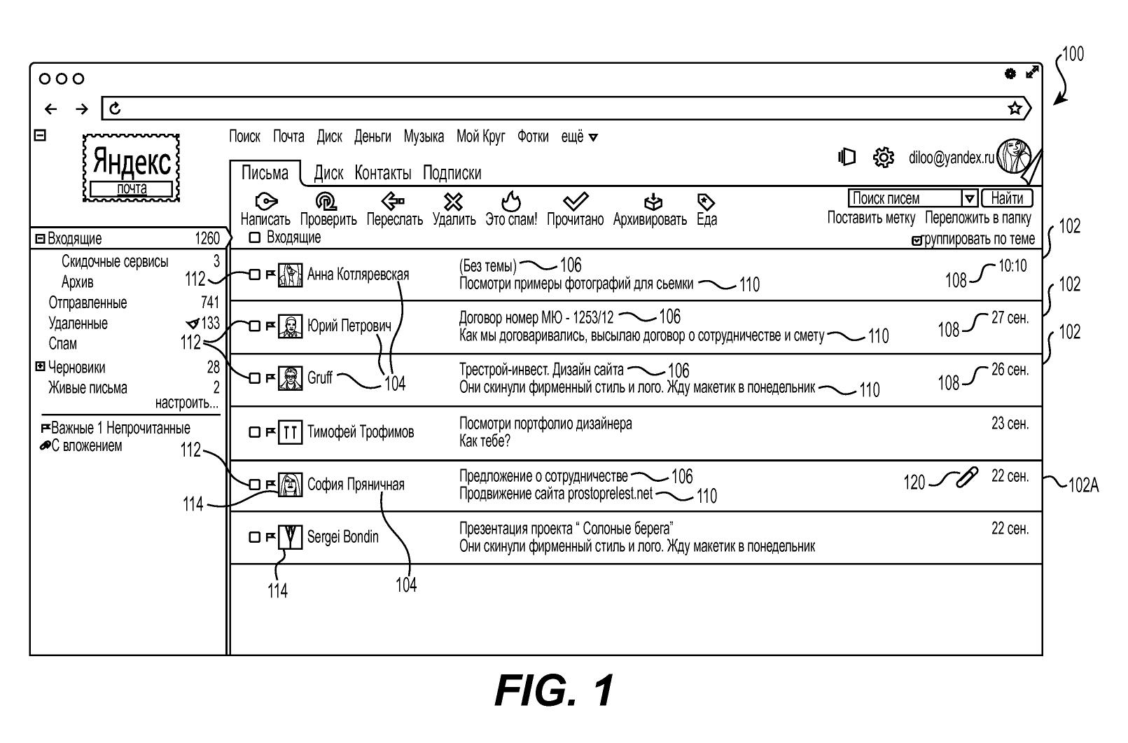

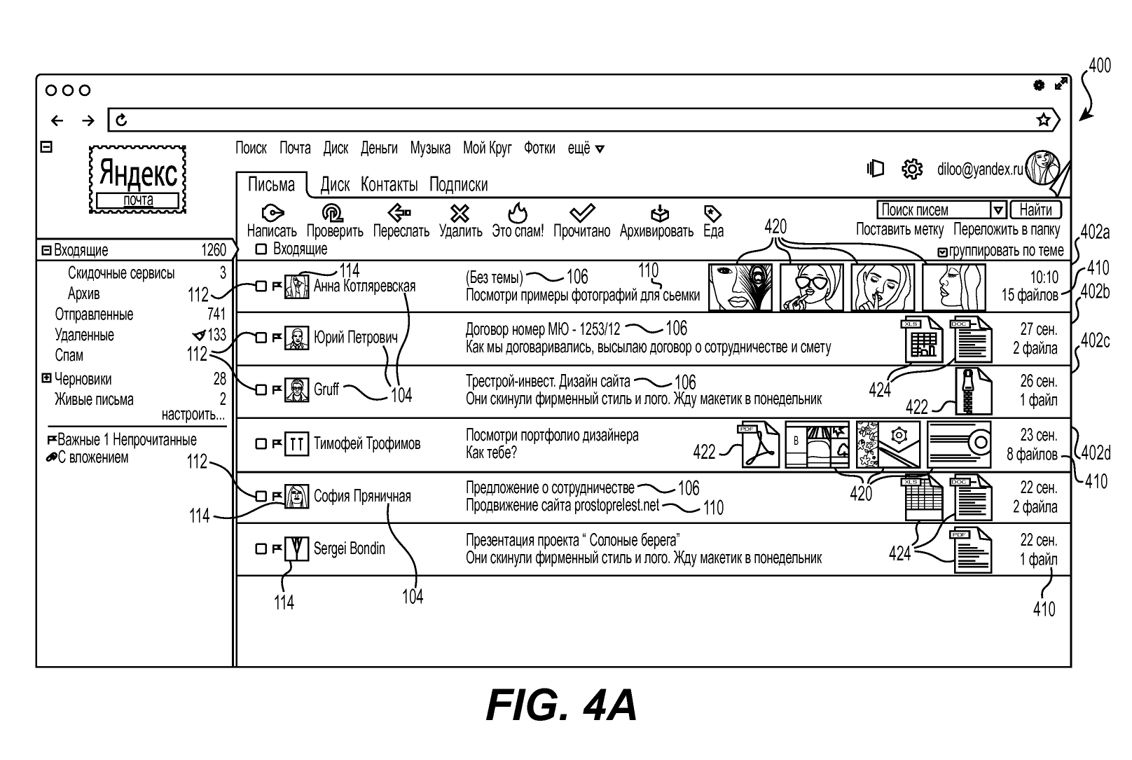

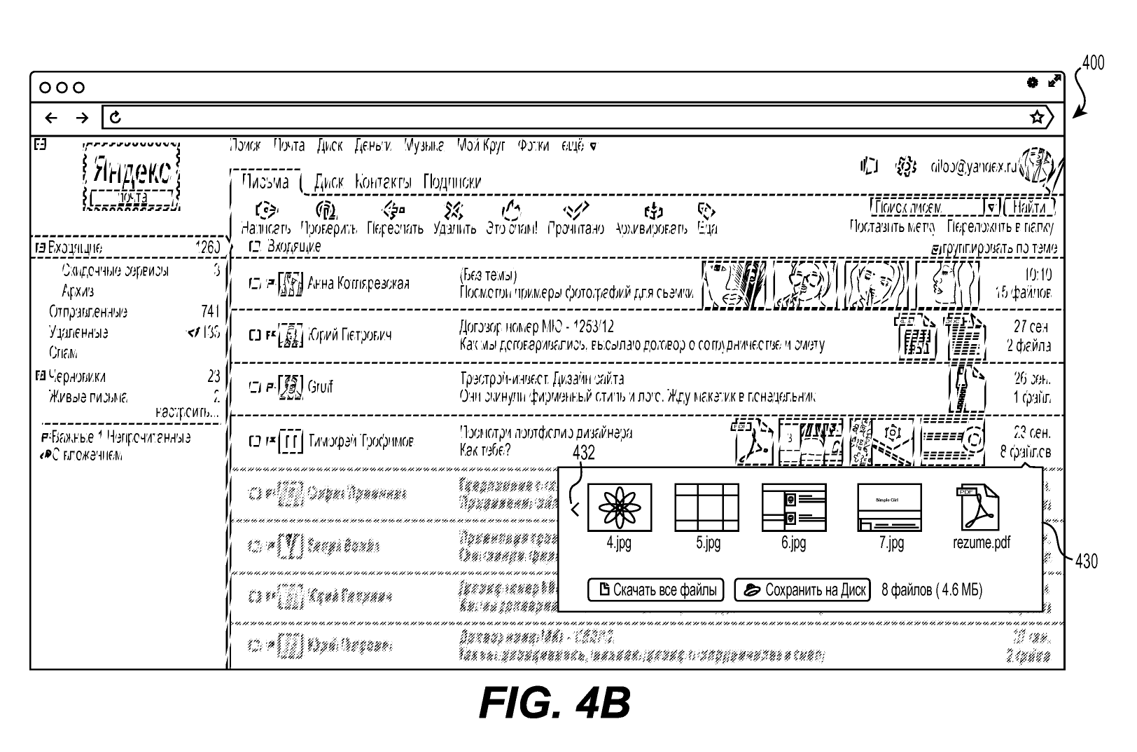

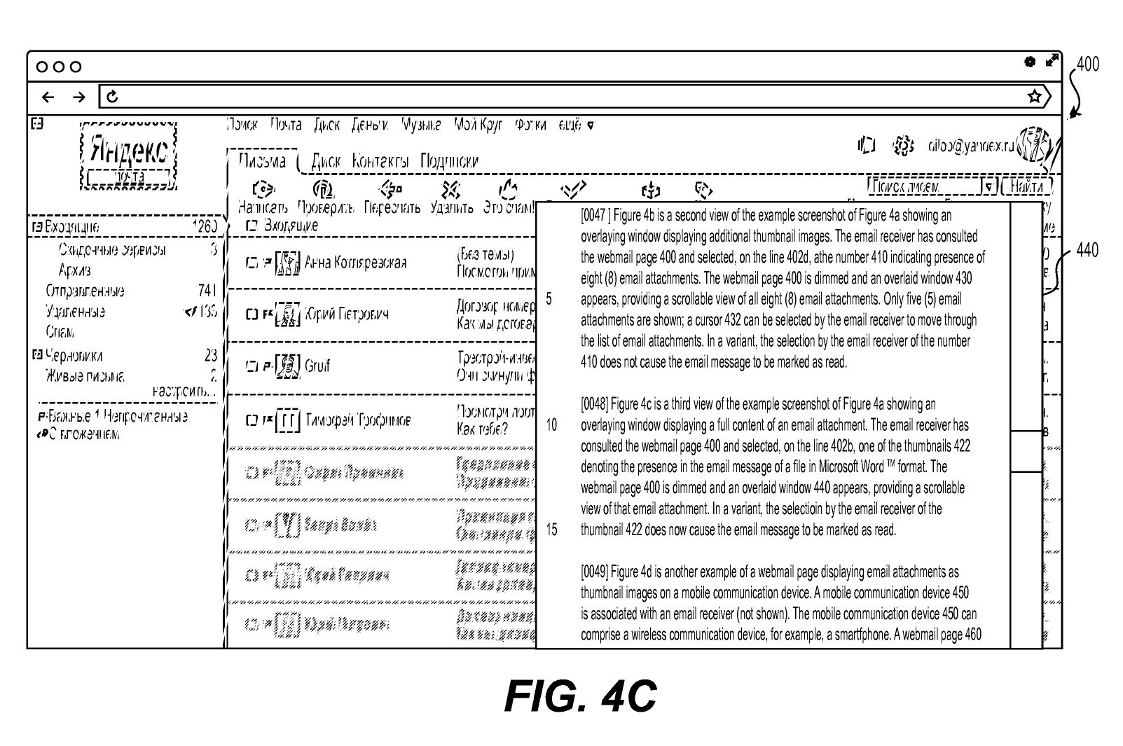

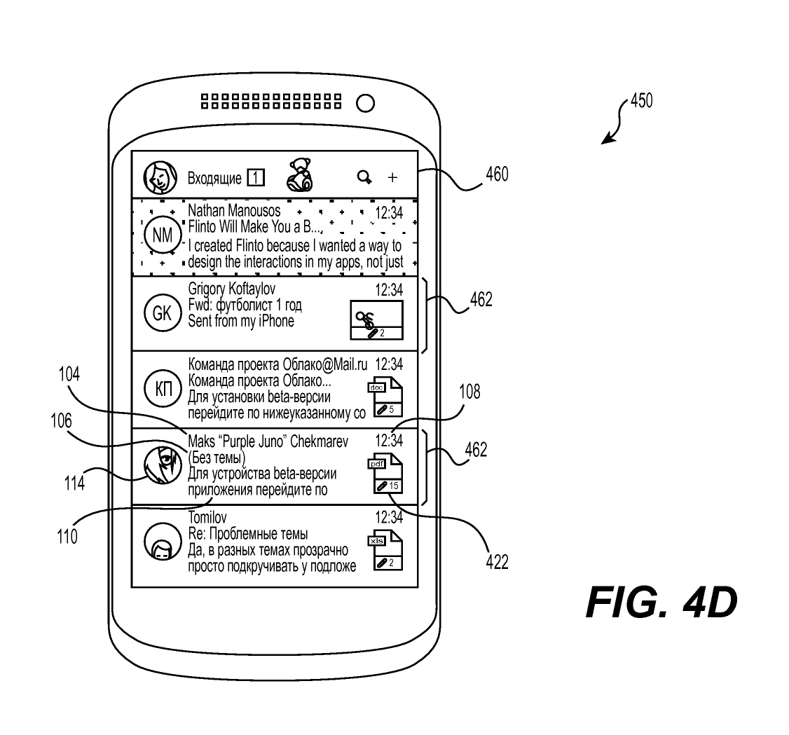

FIG. 4a is an example screenshot of a webmail page displaying email attachments as thumbnail images. A webmail page 400 may display all elements of the conventional webmail page 100 of FIG. 1, these elements being described hereinabove. The webmail page 400 shows a plurality of lines 402 (lines 402a-402d are expressly shown) that, together, form a list of recent email messages addressed to the email receiver.

In comparison to the lines 102 of the conventional webmail page 100, the lines 402 show additional fields. A first additional field is a number 410 of attachments included in each email. If a given email does not carry any attachment, the number 410 may be displayed with a value of ‘0’ or may be omitted. If one or more attachments are included in a given email, thumbnails 420, 422 and 424 are shown on the corresponding line 402. In the example of FIG. 4a, though up to 15 email attachments may be included in a particular email message, up to four (4) thumbnails can be displayed on a given line 402. Depending on practical considerations such as for example a size of a screen displaying the webmail page 400, the number of thumbnails that can be shown on a line 402 may be smaller or larger.

FIG. 4a shows three (3) distinct types of thumbnails. Thumbnails 420 are related to email attachments consisting for example of digital image files. The thumbnails 420 consist of scaled down versions of those digital image files. Thumbnails 422 correspond to email attachments for which a preview is not available on the webmail page 400. The thumbnails 422 display a logo of an application program used to create the email attachment, for example an Adobe Acrobat™ logo or a WinZIP™ logo. These logos provide an indication to the email receiver of the type of program that should be used to consult the email attachment. Thumbnails 424 correspond to email attachments, other than image files, for which a preview is available. Each thumbnail 424 shows a scaled down partial view, for example a first page or part thereof, of the content of the email attachment. A thumbnail 424 is therefore a visual representation of at least a part of the particular attachment. As an email attachment may consist of a multi-page file, the corresponding thumbnail 424 may be an image of a first page of the multi-page file. Each thumbnail 424 optionally shows a logo of a program used to create the email attachment, for example an Adobe Acrobat™ logo, a Microsoft Excel™ logo, or a Microsoft Word™ logo. The thumbnails 402, 422 and 424 as shown on FIG. 4a are provided for purposes of illustration and do not limit the present technology.

FIG. 4b is a second view of the example screenshot of FIG. 4a showing an overlaying window displaying additional thumbnail images. The email receiver has consulted the webmail page 400 and selected, on the line 402d, the number 410 indicating presence of eight (8) email attachments. The webmail page 400 is dimmed and an overlaid window 430 appears, providing a scrollable view of all eight (8) email attachments. Only five (5) email attachments are shown; a cursor 432 can be selected by the email receiver to move through the list of email attachments. In a variant, the selection by the email receiver of the number 410 does not cause the email message to be marked as read.

FIG. 4c is a third view of the example screenshot of FIG. 4a showing an overlaying window displaying a full content of an email attachment. The email receiver has consulted the webmail page 400 and selected, on the line 402b, one of the thumbnails 422 denoting the presence in the email message of a file in Microsoft Word™ format. The webmail page 400 is dimmed and an overlaid window 440 appears, providing a scrollable view of that email attachment. In a variant, the selection by the email receiver of the thumbnail 422 does not cause the email message to be marked as read.

FIG. 4d is another example of a webmail page displaying email attachments as thumbnail images on a mobile communication device. A mobile communication device 450 is associated with an email receiver (not shown). The mobile communication device 450 can comprise a wireless communication device, for example, a smartphone. A webmail page 460 visible on the mobile communication device 450 has similar features as the webmail page 400 of FIGS. 4a and 4b, but is reformatted and resized for viewing on a smaller screen of the mobile communication device 450. The lines 402 of the webmail page 400 are replaced on the webmail page 460 by short paragraphs 462 representing email messages intended for a user of the mobile communication device 450. Each paragraph 462 shows an identity 104 of a sender of the email message, a title 106 of the email message, a date or time 108 when the email message was sent from the sender, first few words 110 of a text content of the email message, a small picture 114 representing the sender (if available), and a thumbnail 420, 422 or 424, if an attachment is included in the email message.

Variants of the webmail page 460 showing more or less information than as illustrated on FIG. 4d, displaying the first few words 110 of the text content on more or less lines, or showing more than one thumbnail 420, 422 or 424 for each email message, are also contemplated. Modifications to the actual content of the webmail page 460 may be made as appropriate for a screen size of the mobile communication device 450 or for similar considerations.

Though not shown, selection by the email receiver of a field of any of the paragraphs 462, for example the selection of the thumbnail 420, 422 or 424, can result in the dimming of the webmail page 460 and the overlaying of another window displaying additional thumbnails, in the manner shown in the foregoing description of FIG. 4b. The additional window may be scrollable to allow the email receiver to view any number of thumbnails. Likewise, selection by the email receiver of one of the thumbnail 420, 422 or 424 can result in the dimming of the webmail page 460 and the overlaying of another window displaying a content of the email attachment corresponding to the selected thumbnail, or a part thereof, in the manner shown in the foregoing description of FIG. 4c.

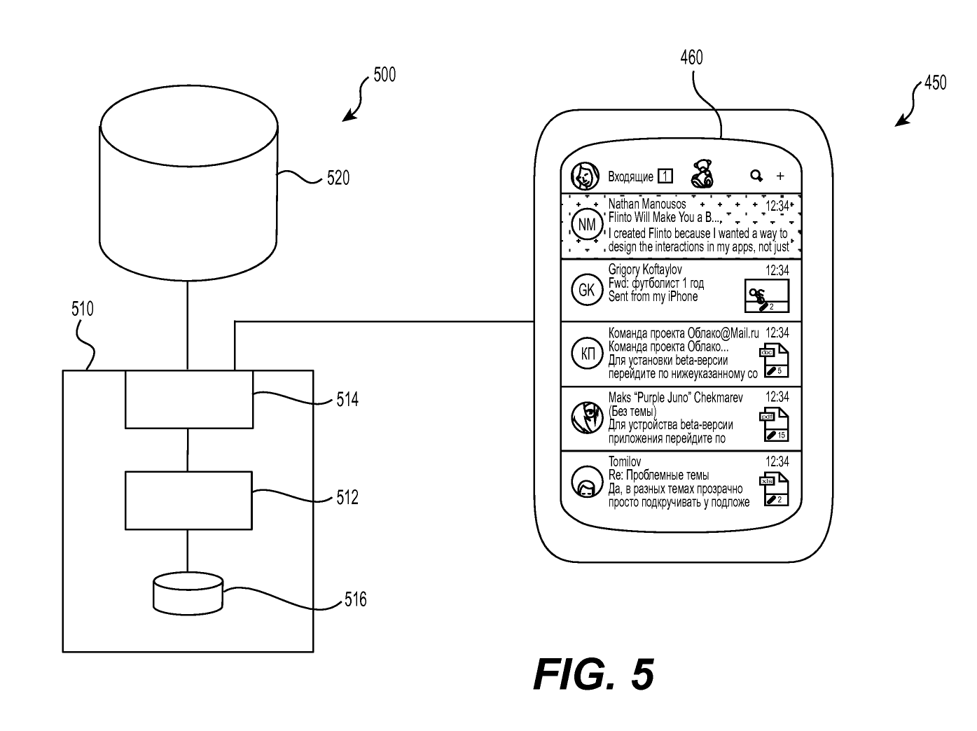

FIG. 5 is a block diagram showing elements of a system for displaying email attachments on a webmail page according to an embodiment. A system 500 for displaying email attachments on a webmail page comprises an email server 510 and an email database 520, and is communicatively coupled, for example to the mobile communication device 450 introduced in the foregoing description of FIG. 4d. The system 500 can also be communicatively coupled to client devices or communication devices of any type, including personal computers, desktops, laptops, netbooks, and the like, the communication devices being capable of displaying the webmail page 400 or an equivalent. Mention of the mobile communication device 450 in the present description of FIG. 5 is made for illustration only and does not limit the present technology. Additionally, though one (1) mobile communication device 450 is shown on FIG. 5, it should be understood that the system 500 can communicate with and serve a large number of client devices. The system 500 may comprise a plurality of additional components, as is well known to the reader skilled in the art of computer systems. Some of the components of the system 500 are not shown on FIG. 4 in order to simplify the illustration.

The email server 510 includes a computer processor 512. The email server 510 also includes a communication interface 514 operationally connected with the computer processor 512 and structured and configured to communicate with the email database 520 and with the mobile communication device 450 or with a communication device of any type.

The system 500 may comprise a plurality of email servers and/or a plurality of email databases. Plural email servers can operate in redundancy mode or in task sharing mode. Likewise, plural email databases can operate in redundancy mode or in task sharing mode. The system 500 as illustrated shows one email server 510 and one email database 520 without limiting the present technology, for the sole purpose of to simplifying the present illustration.

Though a single computer processor 512 is shown, the email server 510 may comprise a plurality of computer processors. Reference to “a” computer processor 512 is made to simplify the present illustration. Likewise, the email server 510 may comprise a plurality of communication interfaces, including for example a communication interface of a first type for communicating with the email database 520 and a communication interface of a second type for communicating with the mobile communication device 450. Of course, the email server 510 may communicate with a large number of distinct communication devices and may use a second type of communication interface for communicating with some client devices and a third type of communication interface for communicating with other client devices. Reference to “a” communication interface 514 is therefore made to simplify the present illustration.

A non-transient computer information storage medium 516 of the email server 510 is operationally connected with the computer processor 512. The non-transient computer information storage medium 516 is not limited to a single device but may consist of an assemblage of a plurality of storage media. The non-transient computer information storage medium 516 stores program instructions that are executable by the computer processor 512 to effect:
receiving, from the mobile communication device 450 associated with the email receiver, a request for pending email messages for the email receiver;
retrieving, from the email database 520, of one or more pending email messages having a destination address designating the email receiver, the one or more pending email messages including an email message having at least one email attachment; and
sending to the mobile communication device 450 a trigger, the trigger being instrumental in causing the communication device to display a webmail page viewable by the email receiver, the webmail page showing, on each of one or more lines, an identity of a sender of one of the one or more pending email messages and a title of the one of the one or more pending email messages, the webmail page further showing, on a line for the email message having the at least one email attachment, at least one thumbnail representative of the at least one email attachment.

The program instructions stored in the non-transient computer information storage medium 516 are further executable by the computer processor 512 so that the system 500 executes the operations of the method for displaying email attachments on a webmail page of FIG. 2 and the operations of the method for preparing an email message for presentation of an email attachment in the form of a thumbnail of FIG. 3.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A method for displaying email attachments on a webmail page, the method comprising:
receiving at an email server, from a communication device associated with an email receiver, a request for received email messages;
retrieving, by the email server from an email database, two or more received email messages, each of the two or more received email messages having at least one email attachment; and
sending, by the email server to the communication device, a trigger, the trigger being instrumental in causing the communication device to display a webmail page viewable by the email receiver, the webmail page showing two or more lines, each line relating to a respective one of the two or more received email messages,
each line showing an identity of a sender and a title of a respective one of the two or more received email messages,
each line further showing at least one thumbnail representative of the at least one email attachment.

2. The method of claim 1, further comprising generating the at least one thumbnail.

3. The method of claim 2, wherein generating the at least one thumbnail comprises:
receiving, at the email server, an email message having a source address designating a sender of the email message and the destination address designating the email receiver;
locating, by the email server, within the email message, at least one email attachment;
extracting, by the email server, from the email message, the at least one email attachment;
creating, by the email server, for each of the at least one email attachment, a thumbnail illustrating a content of the at least one email attachment; and
storing, in an email database by the email server, the email message and each of the at least one thumbnail so created, the storing including establishing a relation between a database address designating the email message and a database address designating each of the at least one thumbnail.

4. The method of claim 3, further comprising using the relation between the database address designating the email message and the database address designating each of the at least one thumbnail to retrieve, by the email server from the email database, the at least one thumbnail.

5. The method of claim 2, wherein the at least one thumbnail is generated prior to receiving the request for received email messages.

6. The method of claim 2, wherein the at least one thumbnail is generated concurrently with treating the request for received email messages.

7. The method of claim 6, further comprising, while the at least one thumbnail is being generated, sending to the communication device a first trigger instrumental in causing the communication device to display, on at least one of the two or more lines, a pseudo thumbnail indicative of the at least one email attachment.

8. The method of claim 7, further comprising sending to the communication device a second trigger instrumental in causing the communication device to replace the pseudo thumbnail with the at least one thumbnail responsive to the at least one thumbnail having been generated.

9. The method of claim 1, comprising receiving the request for received email messages from a browser associated with the communication device.

10. The method of claim 1, wherein the communication device is a wireless communication device and wherein the request for received email messages is received from a device application associated with the wireless communication device.

11. The method of claim 1, wherein the trigger is further instrumental in causing the communication device to generate the webmail page.

12. The method of claim 1, wherein a particular thumbnail corresponding to a particular attachment is a visual representation of at least a part of the particular attachment.

13. The method of claim 12, wherein the particular attachment is a digital image and the thumbnail is a scaled down version of the digital image.

14. The method of claim 12, wherein the particular attachment is a multi-page file and the thumbnail is an image of a first page of the multi-page file.

15. The method of claim 1, wherein a particular attachment is a file created with an application program and a particular thumbnail corresponding to the particular attachment comprises a logo representing the application program.

16. The method of claim 1, wherein at least one of the two or more lines further shows an indication of a number of attachments included in a corresponding one of the two or more received email messages.

17. The method of claim 16, further comprising:
detecting, by the email server, a selection by the email receiver of the indication of the number of attachments; and
overlaying, by the email server, over the webmail page, a window showing all thumbnails for the corresponding one of the two or more received email messages.

18. The method of claim 1, further comprising:
detecting, by the email server, a selection by the email receiver of a given one of the at least one thumbnail; and
overlaying, by the email server, over the webmail page, a window showing a content of the attachment corresponding to the given one of the at least one thumbnail.

19. The method of claim 18, wherein the window showing the content of the attachment corresponding to the given one of the at least one thumbnail is scrollable to show the complete content of the shown attachment.

20. The method of claim 18, wherein the selection by the email receiver of the given one of the at least one thumbnail does not cause the email message to be marked as read.

21. The method of claim 1, wherein the at least one email attachment is embedded within a content of the email message, the content of the email message further including at least one hypertext markup language (HTML) element, the method further comprising distinguishing the at least one email attachment from the at least one HTML element.

22. The method of claim 11, further comprising not counting the at least one HTML element as an attachment to the email message.

23. A system for displaying email attachments on a webmail page, comprising an email server, the email server including:
at least one computer processor;
a communication interface operationally connected with the computer processor and structured and configured to communicate with an email database and with at least one communication device associated with an email receiver;
a non-transient computer information storage medium operationally connected with the computer processor, the non-transient computer information storage medium storing program instructions that when executed by the at least one computer processor effect:
receiving, from the communication device associated with the email receiver, a request for received email messages;
retrieving, from the email database, two or more received email messages, each of the two or more received email messages having at least one email attachment; and
sending to the communication device a trigger, the trigger being instrumental in causing the communication device to display a webmail page viewable by the email receiver, the webmail page showing two or more lines, each line relating to each one of the two or more received email messages,
each line showing an identity of a sender and a title of a respective one of the two or more received email messages,
each line further showing at least one thumbnail representative of the at least one email attachment.
